(19) United States
(12) Patent Application Publication
(10) Pub. No.: US 2022/0074021 A1
(43) Pub. Date: Mar. 10, 2022

(54) Method for Extracting Gold and/or Silver and/or at Least One Platinum Metal

(71) Applicant: Robert Bosch GmbH, Stuttgart (DE)

(72) Inventors: Juergen Hackenberg, Sachsenheim (DE); Claudio Baldizzone, Stuttgart (DE)

(21) Appl. No.: 17/423,255

(22) PCT Filed: May 7, 2019
(86) PCT No.: PCT/EP2019/061672

§ 371 Date: Jul. 15, 2021

(30) Foreign Application Priority Data
Mar. 1, 2019 (DE) 10 2019 202 779.2

(51) Int. Cl. C22B 11/08; C22B 11/00; C22B 7/00

(52) U.S. Cl. CPC C22B 11/08; C22B 7/006; C22B 11/04

(57) ABSTRACT

A process for the winning of at least one of gold, silver, and at least one platinum metal includes introducing at least one starting material containing at least one of gold, silver, and at least one platinum metal into an aqueous solution containing at least one nitrile, and producing hydroxyl radicals in the aqueous solution.

The present invention relates to a process for the winning of gold and/or silver and/or at least one platinum metal from at least one starting material.

### PRIOR ART

Gold, silver and platinum metals are essential raw materials. The recovery of these from valuable scrap, for example as part of catalyst materials or of electronic appliances, can be carried out pyrometallurgically or hydrometallurgically. Pyrometallurgical recovery is carried out by melting the used metals and then treating them by various processes. However, this is very energy intensive and associated with the formation of toxic emissions. In hydrometallurgical recovery, the metals to be recovered are brought into aqueous solutions by complexation. An example of such a process is alkaline cyanide leaching for the winning of gold. This process is carried out at very high pH values, i.e. using aggressive alkalis. The complex former used, namely cyanide, is very toxic, so that this process can also lead to hazardous emissions. In particular, the pH of a cyanide-containing solution can, for example, increase as a result of absorption of carbon dioxide from the surrounding air to such an extent that hydrocyanic acid is released as gas from the solution.

### DISCLOSURE OF THE INVENTION

The process serves for the winning of gold and/or silver and/or at least one platinum metal from at least one starting material, in particular from valuable scrap or from naturally occurring ores. For the purposes of the present invention, platinum metals (platinum group metal; PGM) are the light platinum metals ruthenium, rhodium and palladium and the heavy platinum metals iridium and platinum. Used metals are processed metals in any form, for example metals as part of catalysts or metals as part of electronic appliances. The at least one starting material containing gold and/or silver and/or at least one platinum metal is introduced into an aqueous solution containing at least one nitrile. The nitrile is, in particular, selected from the group consisting of acetonitrile, isobutyronitrile and propionitrile, with particular preference being given to acetonitrile. Hydroxyl radicals are generated in the aqueous solution. Reaction of the hydroxyl radicals with the nitrile makes it possible to produce, in situ, such an amount of cyanides (ions or free radicals) as is required for bringing the metal to be recovered into solution. At the same time, the hydroxyl radicals can function as oxidant for the metal. As a result, it is neither necessary to work with large excesses of cyanides, nor is the use of large amounts of strong alkalis required.

In one embodiment of the process, the hydroxyl radicals are generated by introducing ozone into the solution. This can react with water to form oxygen and hydroxyl radicals, with the reaction being carried out, in particular, photocatalytically. The ozone required for this purpose can, for example, be produced by corona discharges or electrochemically.

In this embodiment of the process, the solution preferably contains from 0.1 mol per liter to 1.0 mol per liter of at least one alkali metal hydroxide, in particular sodium hydroxide or potassium hydroxide. Owing to the targeted formation of cyanides (ions or free radicals) and the oxidizing action of the hydroxyl radicals, this amount of the alkali metal hydroxide is sufficient to prevent formation of gaseous hydrocyanic acid effectively.

Furthermore, preference is given in this embodiment of the process to the ozone being introduced into the solution through a porous diffuser below the starting material. As a result, it flows around the starting material and the formation of the hydroxyl radicals occurs in the vicinity of the surface of the starting material.

In this embodiment, it is also preferred that the solution flows in the same direction as the ozone as the starting material. As a result, fresh solution is enriched with ozone before it contacts the starting material and, after contact with the starting material, can be discharged together with metal cyano complexes dissolved therein from a reactor used for the process.

In another embodiment of the process, the hydroxyl radicals are produced in the solution by a Fenton reaction. The Fenton reaction is a reaction of hydrogen peroxide in acidic solution catalyzed by an iron salt. For this purpose, the solution can contain, in particular, Fenton's reagent, namely a sulfuric acid mixture of hydrogen peroxide and an iron salt. Iron(II) sulfate is particularly suitable as iron salt.

While a pure electro-Fenton reaction requires a strongly acidic solution in order to neutralize hydroxyl anions formed in the process, the production of hydroxyl radicals can also be carried out in a weakly acidic solution by, for example, combination of the electro-Fenton reaction with a photo-Fenton reaction, for which purpose the solution preferably contains formic acid. This reduces the risk of formation of gaseous hydrocyanic acid by liberation of cyanide ions from metal cyano complexes.

In all embodiments of the process, the solution preferably contains at least 0.1 mol per liter of the at least one nitrile in order to make available a sufficiently large source for the production of cyanides (ions or free radicals).

Furthermore, preference is given to the solution containing at least one substance selected from the group consisting of alcohols, surfactants and activated carbons. Among alcohols, preference is given to the short-chain alcohols methanol, ethanol and isopropanol. Like the surfactants, the alcohols bring about improved wetting of the at least one starting material by the aqueous solution. The activated carbon has a high surface area at which the formation of hydroxyl radicals can proceed.

Furthermore, the solution is preferably irradiated with UV light. Photocatalysis of the reaction can in this way be achieved in the formation of hydroxyl radicals by introduction of ozone into the solution. For this purpose, the UV light preferably has a wavelength of less than 310 nm. In production of hydroxyl radicals by a Fenton reaction, irradiation makes the occurrence of a photo-Fenton reaction possible. For this purpose, the wavelength of the UV light used is preferably less than 580 nm.

### BRIEF DESCRIPTION OF THE DRAWINGS

Working examples of the invention are depicted in the drawings and are explained in more detail in the following description.

FIG. 1 schematically shows a reactor in which a process as per a working example of the invention proceeds.

FIG. 2 schematically shows another reactor in which a process as per another working example of the invention proceeds.

### WORKINGS EXAMPLES OF THE INVENTION

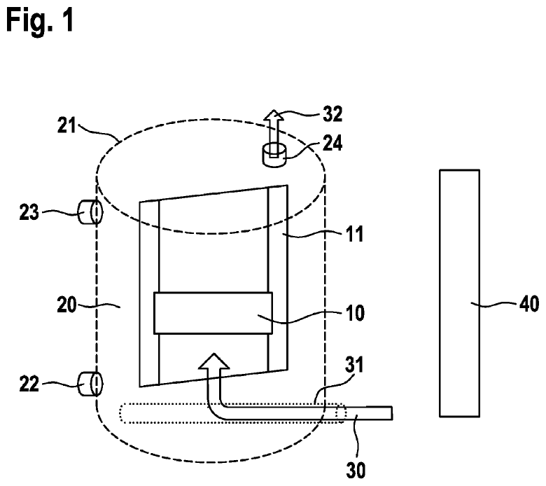

FIG. 1 shows how, in a working example of the invention, gold can be dissolved from a nickel substrate in a starting material 10, which in the present case is a printed circuit board. For this purpose, the starting material 10 is fastened in a frame 11. This is covered by an aqueous solution 20 which is stocked in a reactor 21. Fresh solution is continuously supplied through an inlet opening 22 which is arranged below the starting material 10 on the wall of the reactor 21, while solution enriched with cyano complexes of gold is discharged through an outlet opening 23 arranged above the starting material 10 in the wall of the reactor 21. The aqueous solution 20 contains 0.5 mol/l of acetonitrile and 0.5 mol/l of sodium hydroxide in the present working example. It additionally contains methanol, surfactants and activated carbons. Ozone 30 is introduced into the reactor 21 through a porous diffuser 31 which is arranged in the reactor 21 below the starting material 10 and below the inlet opening 22. It mixes with the fresh solution 20 which is introduced through the inlet opening 22 into the reactor 21 and flows around the starting material 10. The reactor 21 consists of a transparent material and is irradiated from the outside with light having a wavelength of less than 310 nm by means of a UV lamp 40. The ozone reacts photocatalytically with water molecules to form oxygen and hydroxyl radicals according to formula 1:

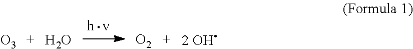

A mixture 32 of unreacted ozone and the oxygen formed leaves the reactor 21 through a gas outlet 24 on its upper side.

The hydroxyl radicals undergo essentially two reactions in the solution 20:

According to formula 2, hydroxyl radicals react with the acetonitrile to form methanol and cyano radicals. These oxidize metallic gold to gold(I) cyanide:

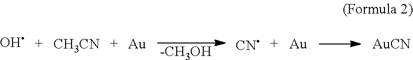

Furthermore, the hydroxyl radicals can oxidize gold at the metal surface itself to form gold(I) hydroxide according to formula 3. This is highly reactive and reacts with the acetonitrile to form methanol and gold(I) cyanide:

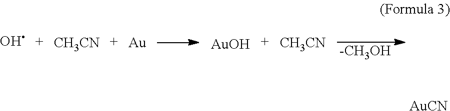

The gold(I) cyanide goes into solution and leaves the reactor through the outlet opening 23. The gold can subsequently be precipitated from the cyanide leachate solution by known methods and the solution can subsequently be reintroduced into the reactor 21 through the inlet opening 22. In this way, from 0.5 to 2 milligrams of gold per square centimeter of surface of the starting material 10 and per hour can be obtained in the present working example. As soon as all the gold has been removed, no further metal goes into solution since nickel forms an inert protective layer composed of nickel hydroxide under alkaline conditions.

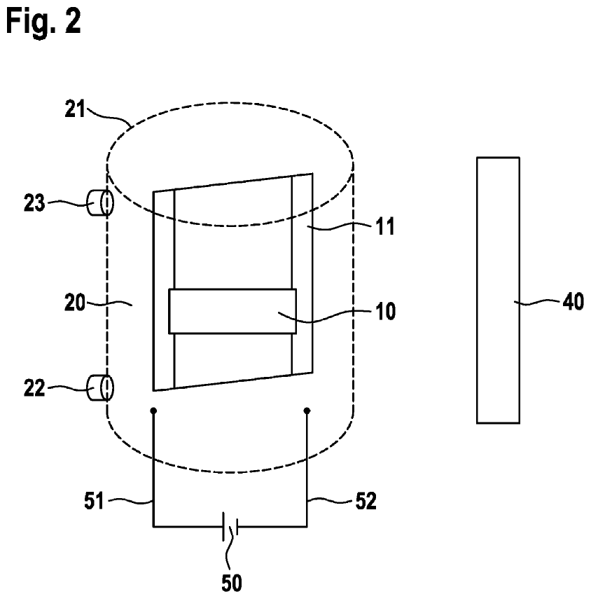

In a second working example of the process, a reactor 21 as depicted in FIG. 2 is used. This differs from the reactor of FIG. 1 in that the porous diffuser 31 for the introduction of ozone 30 and the gas outlet opening are omitted. Instead, an electric energy source 40 which is connected to two electrodes 51, 52 projecting into the reactor 21 below the starting material 10 is provided. In this working example, the aqueous solution additionally contains iron(II) sulfate and is continuously enriched with hydrogen peroxide by formation at a cathode before introduction through the inlet opening 22 through a conduit which is not shown. It contains 0.5 mol/l of formic acid instead of 0.5 mol/l of sodium hydroxide. As a result of application of an electric potential between the electrodes 51, 52, an electro-Fenton reaction according to formula 4 proceeds in the solution 20 within the reactor 21:

Fe²⁺+H₂O₂→Fe³⁺+OH⁻+OH⁺ (Formula 4)

The irradiation by means of the UV lamp 40 occurs at a wavelength of less than 580 nm. As a result, a photo-Fenton reaction according to formula 5 also proceeds in the solution 20:

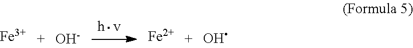

The photo-Fenton reaction brings about both regeneration of the iron(II) cations which have been oxidized in the electro-Fenton reaction by reduction and also neutralization of the hydroxyl anions produced there so that the pH of the solution 20 does not change. The hydroxyl radicals produced in the two Fenton reactions then react further as in the first working example of the process according to the formulae 2 and 3 and bring gold into solution in the form of gold(I) cyanide. The taking of the solution 20 enriched with gold(I) cyanide from the reactor 21 and the precipitation of metallic gold are effected in the same way as in the first working example.

1. A process for the winning of at least one of gold, silver, and at least one platinum metal, comprising:
introducing at least one starting material containing at least one of gold, silver, and at least one platinum metal into an aqueous solution containing at least one nitrile; and
producing hydroxyl radicals in the aqueous solution.

2. The process as claimed in claim 1, wherein producing the hydroxyl radicals comprises:
introducing ozone into the solution to produce the hydroxyl radicals.

3. The process as claimed in claim 2, wherein the aqueous solution contains from 0.1 mol/l to 1.0 mol/l of at least one alkali metal hydroxide.

4. The process as claimed in claim 2, wherein the ozone is introduced into the solution through a porous diffuser below the at least one starting material.

5. The process as claimed in claim 2, further comprising:
flowing the aqueous solution (20) flows and the ozone in the same direction over the starting material.

6. The process as claimed in claim 1, wherein producing the hydroxyl radicals comprises:
producing the hydroxyl radicals by a Fenton reaction in the aqueous solution.

7. The process as claimed in claim 6, wherein the aqueous solution contains formic acid.

8. The process as claimed in claim 1, wherein the aqueous solution contains at least 0.1 mol/l of the at least one nitrile.

9. The process as claimed in claim 1, wherein the aqueous solution contains at least one substance selected from the group consisting of alcohols, surfactants and activated carbon.

10. The process as claimed in claim 1, wherein the aqueous solution is irradiated with UV light.
